(19) United States
(12) Patent Application Publication
(10) Pub. No.: US 2022/0358685 A1
(43) Pub. Date: Nov. 10, 2022

(54) IMAGE ENCODING METHOD AND IMAGE DECODING METHOD

(71) Applicant: NIPPON TELEGRAPH AND TELEPHONE CORPORATION, Tokyo (JP)

(72) Inventors: Shiori SUGIMOTO, Musashino-shi, Tokyo (JP); Seishi TAKAMURA, Musashino-shi, Tokyo (JP); Atsushi SHIMIZU, Musashino-shi, Tokyo (JP)

(73) Assignee: NIPPON TELEGRAPH AND TELEPHONE CORPORATION, Tokyo (JP)

(21) Appl. No.: 17/621,592

(22) PCT Filed: Jun. 24, 2019
(86) PCT No.: PCT/JP2019/024859

§ 371 Date: Dec. 21, 2021

(51) Int. Cl. G06T 9/40; G06T 3/40

(52) U.S. Cl. CPC G06T 9/40; G06T 3/40

(57) ABSTRACT

An image encoding method that expresses an image using pixels or blocks, and colors assigned to the pixels or the blocks when encoding an image to be encoded, and encodes a block division tree and color information, the color information being assigned to all nodes including a root node, branch nodes, and leaf nodes of the block division tree, the method includes: a division tree generation step of dividing the image to be encoded using an arbitrary division tree and thereby generating the block division tree; a color information determination step of determining representative colors that represent interim blocks or final blocks and assigning the determined colors as color information corresponding to the respective nodes, the interim blocks or the final blocks corresponding to the nodes of the block division tree; a tree encoding step of encoding the block division tree; and a color information encoding step of encoding the color information.

### TECHNICAL FIELD

The present invention relates to an image encoding method and an image decoding method.

### BACKGROUND ART

Typical image encoding involves orthogonally transforming an image domain into a frequency domain using DCT (Discrete Cosine Transform), DST (Discrete Sine Transform), wavelet transform, or the like and then doing entropy coding. Because a transform basis and an image are identical in dimension, the number of data items remains unchanged and the amount of information remains unreduced after the transform, but distribution of the data is deviated by the transform, improving coding efficiency of the entropy coding. Also, in so doing, if a high-frequency component whose rate of contribution to subjective image quality is said to be low is coarsely quantized, the amount of information can be reduced further.

Also, in the case of video encoding, in which plural images need to be compressed efficiently in particular, to further increase a compression ratio, the images are divided into processing unit blocks and an image signal of a subject is spatially/temporally predicted on a block by block basis using special/temporal continuity of the subject. By encoding prediction information about an image signal prediction method as well as predicted residual signals subjected to the above-mentioned transformation and quantization, it is possible to more greatly improve coding efficiency than when the image signals themselves are encoded.

Image/video coding standards such as JPEG (Joint Photographic Experts Group), H.264/MPEG—4AVC (Moving Picture Experts Group—Advanced Video Coding), and H.265/HEVC (High Efficiency Video Coding) controls a generated code amount by adjusting a QP (Quantization Parameter) used in quantizing DCT and DST coefficients. On the other hand, a loss of a high-frequency component caused by an increase in the QP and block distortion occurring at block boundaries affect image quality, resulting in a loss of context information depending on the image to be handled.

In this way, generally a method that reduces an amount of information by converting an image into a frequency domain and quantizing the image is in the mainstream. On the other hand, there is another method called palette encoding that treats a palette (color palette) and an index as objects to be encoded, where the palette is a lookup table (color set) in which colors used in an image are arranged and the index is assigned to each pixel in order to refer to the table. The palette encoding is mainly used in images in which a small number of colors appear and images which cannot be expressed efficiently by a transform basis such as DCT intended for natural images.

H.265/HEVC adopts a palette encoding mode as a tool for profiling screen content. The screen content is a generic name of videos other than natural images, such as videos generated by computer graphics. In addition to an index to an ordinary palette, HEVC defines a copy index, which means the use of a same color as adjacent pixels. Therefore, in the case of screen content in which a small number of colors exist locally and a same color continues spatially in many cases, if the palette encoding mode is used on a block by block basis and a small code length is assigned to a copy index, efficient compression is enabled. Note that HEVC palette coding is described in detail, for example, in Non-Patent Literature 1.

On the other hand, if a scan sequence of pixels are fixed and adjacent pixels placed one behind the other in a scanning direction differ from each other in color, a copy index cannot be used even if the same color exists in the vicinity, and there is no choice but to use an ordinary palette index. Also, when a large number of colors exist locally, efficient compression cannot be expected because of an increased amount of information in the palette index.

### CITATION LIST

### Patent Literature

Non-Patent Literature 1: W. Pu, M. Karczewicz, R. Joshi, V. Seregin, F. Zou, J. S ole, Y. C. Sun, T. D. Chuang, P. Lai, S. Liu, S. T. Hsiang, J. Ye, and Y. W. Huang, “Palette Mode Coding in HEVC Screen Content Coding Ex tension,” IEEE Journal on Emerging and Selected Topics in Circuits and Systems, vol. 6, no. 4, pp. 420-432, 2016.

### SUMMARY OF THE INVENTION

### Technical Problem

As described above, when adjacent pixels differ from each other in color or when a large number of colors exist locally, coding efficiency of palette encoding is degraded.

The present invention has been made in view of the above circumstances and has an object to provide an image encoding method and an image decoding method that enable efficient encoding.

### Means for Solving the Problem

According to one aspect of the present invention, there is provided an image encoding method that expresses an image using pixels or blocks, and colors assigned to the pixels or the blocks when encoding an image to be encoded, and encodes a block division tree and color information, the color information being assigned to all nodes including a root node, branch nodes, and leaf nodes of the block division tree, the method comprising: a division tree generation step of dividing the image to be encoded using an arbitrary division tree and thereby generating the block division tree; a color information determination step of determining representative colors that represent interim blocks or final blocks and assigning the determined colors as color information corresponding to the respective nodes, the interim blocks or the final blocks corresponding to the nodes of the block division tree; a tree encoding step of encoding the block division tree; and a color information encoding step of encoding the color information.

### Effects of the Invention

The present invention enables efficient encoding.

### BRIEF DESCRIPTION OF DRAWINGS

FIG. 1 is a block diagram showing a configuration of an image encoding apparatus 100 according to an embodiment of the present invention.

FIG. 2 is a flowchart showing operation of the image encoding apparatus 100 according to the embodiment of the present invention.

FIG. 3 is a block diagram showing a configuration of an image decoding apparatus 200 according to the embodiment of the present invention.

FIG. 4 is a flowchart showing operation of the image decoding apparatus 200 according to the embodiment of the present invention.

### DESCRIPTION OF EMBODIMENTS

An image encoding apparatus 100 and an image decoding apparatus 200 according to an embodiment of the present invention will be described below.

[Functional Configuration of Image Encoding Apparatus]

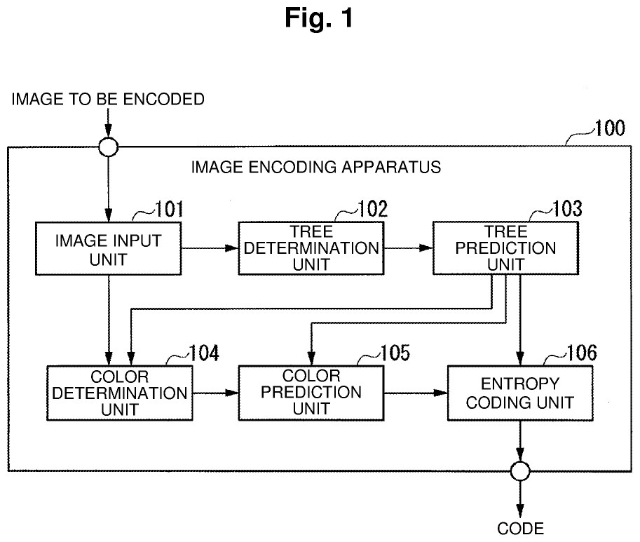

A functional configuration of the image encoding apparatus 100 will be described below with reference to FIG. 1. FIG. 1 is a block diagram showing a configuration of the image encoding apparatus 100 according to the embodiment of the present invention. As shown in FIG. 1, the image encoding apparatus 100 includes an image input unit 101, a tree determination unit 102, a tree prediction unit 103, a color determination unit 104, a color prediction unit 105, and an entropy coding unit 106.

The image input unit 101 accepts input of an image to be processed (hereinafter referred to as an “image to be encoded”), which has been outputted from an external device. The image input unit 101 outputs the image to be encoded to the tree determination unit 102 and the color determination unit 104.

The tree determination unit 102 acquires the image to be encoded, which has been outputted from the image input unit 101. The tree determination unit 102 generates a tree vector (block division tree) from the image to be encoded. Note that the tree may be of any type, such as a binary tree, a ternary tree, or a quadtree, but in the present embodiment, it is assumed, for ease of explanation, that the tree is a quadtree, as an example. The tree determination unit 102 outputs the image to be encoded as well as the generated tree vector to the tree prediction unit 103.

The tree prediction unit 103 acquires the image to be encoded and the tree vector, which have been outputted from the tree determination unit 102. The tree prediction unit 103 generates a tree prediction vector and a tree compression vector from the image to be encoded and the tree vector. The tree prediction unit 103 outputs the generated tree prediction vector and tree compression vector to the color determination unit 104 and the color prediction unit 105, respectively. Also, the tree prediction unit 103 outputs the generated tree compression vector to the entropy coding unit 106.

The color determination unit 104 acquires the image to be encoded, which has been outputted from the image input unit 101. Also, the color determination unit 104 acquires the tree prediction vector and the tree compression vector outputted from the tree prediction unit 103. The color determination unit 104 generates a color vector from the image to be encoded, the tree prediction vector, and the tree compression vector. The color determination unit 104 outputs the image to be encoded and the generated color vector to the color prediction unit 105.

The color prediction unit 105 acquires the tree prediction vector and the tree compression vector outputted from the tree prediction unit 103. Also, the color prediction unit 105 acquires the image to be encoded and color vector outputted from the color determination unit 104. The color prediction unit 105 generates a color compression vector from the image to be encoded, the color vector, the tree prediction vector, and the tree compression vector. The color prediction unit 105 outputs the generated color compression vector to the entropy coding unit 106.

The entropy coding unit 106 acquires the tree compression vector outputted from the tree prediction unit 103. Also, the entropy coding unit 106 acquires the color compression vector outputted from the color prediction unit 105. The entropy coding unit 106 applies entropy coding to the tree compression vector and the color compression vector. The entropy coding unit 106 outputs the code to an external device.

[Operation of Image Encoding Apparatus]

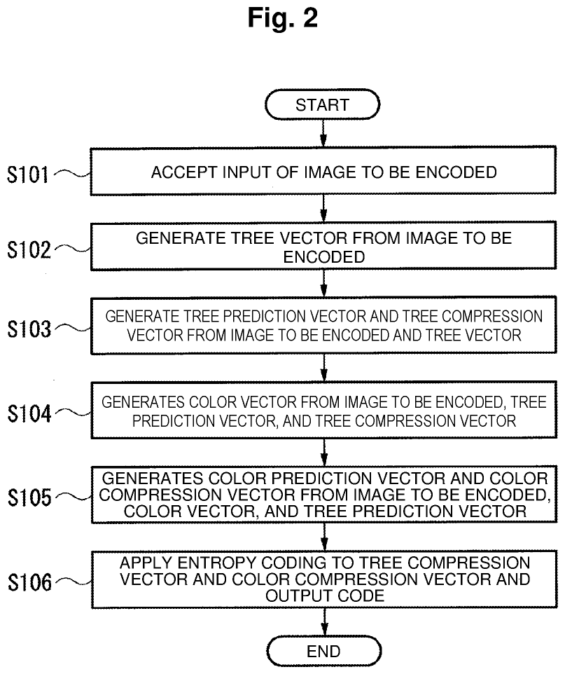

Operation of the image encoding apparatus 100 will be described below with reference to FIG. 2. FIG. 2 is a flowchart showing operation of the image encoding apparatus 100 according to the embodiment of the present invention.

First, the image input unit 101 accepts input of an image to be encoded (step S101). Next, the tree determination unit 102 generates a tree vector from the image to be encoded (step S102). Note that as described above, the tree may be of any type, such as a binary tree, a ternary tree, or a quadtree, but in the following description, it is assumed that the tree is a quadtree.

In the following description, for ease of explanation, it is assumed that an image size of the image to be encoded is 2N in both length and width directions. First, the tree determination unit 102 determines whether to divide the image to be encoded into quarters. Any criterion may be used in this determination. For example, as the simplest criterion, a criterion that the image to be encoded be divided when the number of colors in the image is equal to or larger than a threshold can be used. Here, if the threshold is 2, lossless compression (reversible compression) results.

Note that the determination may be made using statistical information such as a histogram or variance. Alternatively, the determination may be made by calculating a trade-off between amounts of information about a tree structure and color information and amounts of other information (e.g., amounts of information and quality of a decoded image that are needed for orthogonal transformation and quantization or for palette encoding), where the tree structure is produced by division of the image to be encoded.

When the image to be encoded is divided, the tree determination unit 102 assigns a symbol indicating the division to a root node of the tree and furthermore, generates four child nodes. Then, by addressing the child nodes in rotation, the tree determination unit 102 determines, in the same manner as described above, whether to divide the image to be encoded into quarters. If symbol a indicates that the image to be encoded will not be divided and symbol b indicates that the image to be encoded will be divided, the tree vector is a binary vector.

Note that determinations may be made in any order, but in the present embodiment, for ease of explanation, it is assumed that the determinations are made in an order that gives priority to depth. For example, if the image to be encoded has been divided at a node, the tree determination unit 102 further moves to determinations as to child nodes of the node. On the other hand, if the image has not been divided at a node, the tree determination unit 102 moves to determinations as to sibling nodes (nodes arranged in a row) yet to undergo determinations. Note that when determinations as to all the sibling nodes are complete, the tree determination unit 102 moves to determinations as to the sibling nodes of the parent node of the given node.

Next, the tree prediction unit 103 generates a tree prediction vector and a tree compression vector from the image to be encoded and the tree vector (step S103). When the image to be encoded has fractality, a subset of the image is expressed by a downscaled version of another subset and subtree structures representing corresponding parts match each other or one is a rotation or inversion of the other. When tree structures are created using a depth-first search as described above, of subtrees not in a direct parent-child relationship, a tree structure encoded later (predicted subtree) can be predicted by copying, rotating, or determining a tree structure encoded first.

Note that if the image to be encoded is a frame of a video, the tree prediction unit 103 may make a similar prediction using a tree vector used in another encoded frame as a predicted reference source.

When binary tree vectors are used, a determination as to whether a subtree can be predicted by part of an already encoded tree structure can be made rapidly using subvectors representing a target subtree as well as a bit operation on the tree vectors generated so far. When manipulations such as rotation or inversion are involved, a determination can be made if a bit operation is performed after the subvectors are rearranged according to the manipulations. Besides, any determination method may be used.

When a subtree is predicted by referring to another subtree (reference subtree), the tree prediction unit 103 may assign a new symbol to prediction information (tree prediction information) for use to identify a referent and a manipulation, substitute the symbol for the original subvector, and designate the symbol as a tree compression vector. Alternatively, the tree prediction unit 103 may substitute the original subvector with a symbol indicating that only prediction will be used, designate the symbol as a tree compression vector, and express prediction information using another vector.

Note that information identifying a predicted referent may be coordinate information on an image or an index on a tree vector. Alternatively, the information identifying a predicted referent may be depth information identifying a depth of a node based on a tree structure and an index indicating a node position in the depth. Alternatively, the information identifying a predicted referent (tree prediction information) may be a differential (differential tree) from similar information indicating a position of the predicted reference source. Besides, the tree prediction unit 103 may determine whether to make a prediction by comparing an amount of information of a prediction information vector and an amount of information of a vector indicating predicted residual with an amount of information of the original vector to be predicted.

Also, although in the present embodiment, a process of the tree prediction unit 103 is performed before a process of the color determination unit 104, the order of the processes may be reversed. In that case, an optimal referent may be determined such that color information will also be predicted from the reference source.

Next, the color determination unit 104 generates a color vector from the image to be encoded, the tree prediction vector, and the tree compression vector (step S104). The color vector is made up of color information corresponding to all the nodes of the tree prediction vector. When the corresponding nodes are blocks, the color information may indicate an average value of the entire block or a statistic such as a median or a mode.

Note that child node prediction performance may vary greatly depending on what type of information the parent node possesses depending on a color information prediction method described later and a state of the target block. Therefore, information indicating the type of information possessed by each node may be encoded separately as additional information.

The process of the color determination unit 104 and the process of the color prediction unit 10 may be performed simultaneously such that an optimal type of information will be selected. Also, instead of the color information itself, an index to a palette may be used. Also, when corresponding nodes are blocks, an index to a predetermined pattern dictionary may be used instead of the color information itself.

Next, the color prediction unit 105 generates a color prediction vector and a color compression vector from the image to be encoded, the color vector, and the tree prediction vector (step S105). Procedures for generating the color prediction vector and the color compression vector depend on procedures for generating the tree prediction vector. In the present embodiment, for ease of explanation, it is assumed that the tree prediction vector is generated using a depth-first search as described above and that a prediction is made from the root node in a depth-first manner as with the above case.

Note that any prediction method may be used. For example, as a prediction method, parent-child prediction is conceivable, which involves predicting a child node (node to be encoded) using color information about the parent node and adding a predicted value to the color compression vector. In this case, the color prediction unit 105 may add a differential (color information adjacency prediction residual) between a predicted value (color information adjacency prediction value) produced by parent-child prediction and actual color information to the color compression vector. Furthermore, the color prediction unit 105 may predict the differential value from an already encoded other sibling node and add a differential (inter-tree color information prediction residual) between the predicted differential value (inter-tree color information prediction value) and an actual differential value to the color compression vector.

Alternatively, if a subtree including a target node has been predicted by referring to another subtree (reference subtree), the color prediction unit 105 may use the color information on a corresponding node of the predicted referent as a predicted value.

Alternatively, instead of using the color information itself as a predicted value, the color prediction unit 105 may inherit only correlations between parent and child nodes and between sibling nodes of a reference tree and use the correlations in predicting the target node. For example, the color prediction unit 105 may derive a difference in color information between a reference node and the parent node of the reference node, add the difference to color information about the parent node of the target node, and use the resulting sum as a predicted value of the target node.

Alternatively, when an index value to a palette is used as color information, the color prediction unit 105 may inherit the index as it is and creates only the palette to suite a target tree.

Alternatively, if the image to be encoded is a frame of a video, the color prediction unit 105 may predict color information by referring to color information about another encoded frame.

Finally, the entropy coding unit 106 applies entropy coding to the tree compression vector and the color compression vector and outputs code (step S106). Any method for entropy coding may be used. Also, the trees and color information may be aligned in any sequence. For example, the entropy coding unit 106 may scan nodes beginning with the root node in a depth-first manner. Alternatively, for example, the entropy coding unit 106 may arrange all the nodes located at the same depth fist, and then further carry out scans similarly at a location one level deeper.

Note that when scans are carried out at each depth level, even if entropy decoding is terminated halfway during decoding, a low-resolution image can be generated using information obtained down to the depth already decoded.

[Functional Configuration of Image Decoding Apparatus]

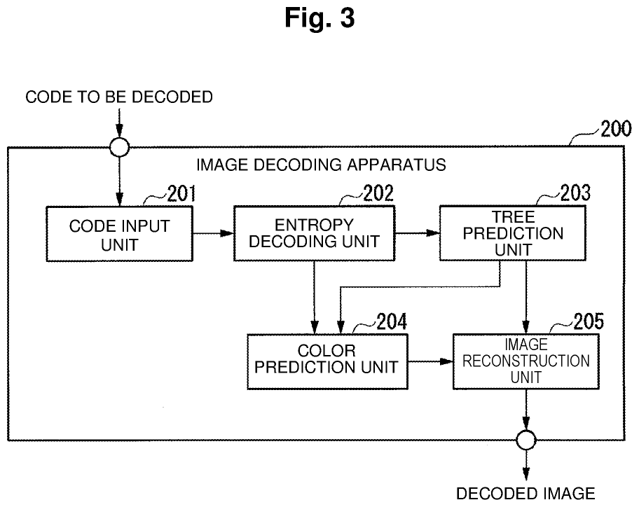

A functional configuration of the image decoding apparatus 200 will be described below with reference to FIG. 3. FIG. 3 is a block diagram showing a configuration of the image decoding apparatus 200 according to the embodiment of the present invention. As shown in FIG. 3, the image decoding apparatus 200 includes a code input unit 201, an entropy decoding unit 202, a tree prediction unit 203, a color prediction unit 204, and an image reconstruction unit 205.

The code input unit 201 accepts input of a code to be processed (hereinafter referred to as a “code to be decoded”), which has been outputted from an external device. The code input unit 201 outputs the code to be decoded to the entropy decoding unit 202.

The entropy decoding unit 202 acquires the code to be decoded, which has been outputted from the code input unit 201. The entropy decoding unit 202 applies entropy decoding to the code to be decoded, and generates a decoded tree compression vector and a decoded color compression vector. The entropy decoding unit 202 outputs the decoded tree compression vector, which has been generated, to the tree prediction unit 203. Also, the entropy decoding unit 202 outputs the decoded color compression vector, which has been generated, to the color prediction unit 204.

The tree prediction unit 203 acquires the decoded tree compression vector, which has been outputted from the entropy decoding unit 202. The tree prediction unit 203 generates a decoded tree vector from the decoded tree compression vector. The tree prediction unit 203 outputs the decoded tree vector, which has been generated, to the color prediction unit 204 and the image reconstruction unit 205.

The color prediction unit 204 acquires the decoded color compression vector, which has been outputted from the entropy decoding unit 202. Also, the color prediction unit 204 acquires the decoded tree vector, which has been outputted from the tree prediction unit 203. The color prediction unit 204 generates a decoded color vector from the decoded color compression vector and the decoded tree vector. The color prediction unit 204 outputs the decoded color vector, which has been generated, to the image reconstruction unit 205.

The image reconstruction unit 205 acquires the decoded tree vector, which has been outputted from the tree prediction unit 203. Also, the image reconstruction unit 205 acquires the decoded color vector, which has been outputted from the color prediction unit 204. The image reconstruction unit 205 generates a decoded image from the decoded tree vector and the decoded color vector. The image reconstruction unit 205 outputs the decoded image, which has been generated, to an external device.

[Operation of Image Decoding Apparatus]

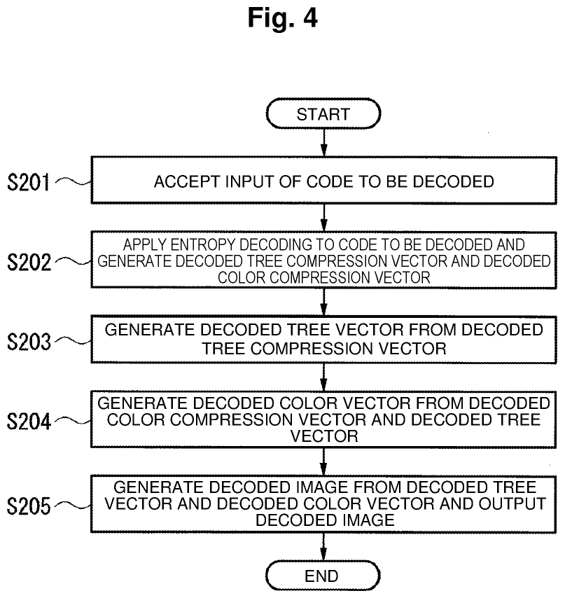

Operation of the image decoding apparatus 200 will be described below with reference to FIG. 4. FIG. 4 is a flowchart showing operation of the image decoding apparatus 200 according to the embodiment of the present invention.

First, the code input unit 201 accepts input of the code to be decoded (step S201). Next, the entropy decoding unit 202 applies entropy decoding to the code to be decoded, and generates a decoded tree compression vector and a decoded color compression vector (step S202).

Next, the tree prediction unit 203 generates a decoded tree vector from the decoded tree compression vector (step S203). Any method for generating a decoded tree vector may be used as long as the method corresponds to a tree structure generation method of the image encoding apparatus 100. If additional information has been encoded separately, the tree prediction unit 203 can decode and use the additional information.

Note that scalable decoding may be implemented by making tree generation terminated halfway. In that case, all branches may be terminated at the same depth or each branch may be terminated at an appropriate depth by making some determination on a branch by branch basis. Also, in that case, a corresponding decoded color compression vector may be used in making the determination as to the termination. Alternatively, a corresponding decoded color vector may be produced simultaneously and a value of the decoded color vector may be used in making the determination as to the termination.

Next, the color prediction unit 204 generates a decoded color vector from the decoded color compression vector and the decoded tree vector (step S204). Any method for generating a decoded color vector may be used as long as the method corresponds to a color information generation method of the image encoding apparatus 100.

Finally, the image reconstruction unit 205 generates a decoded image from the decoded tree vector and the decoded color vector and outputs the decoded image (step S205). The image reconstruction unit 205 identifies a corresponding pixel or block at each leaf node of the decoded tree vector and determines the color of the corresponding pixel using color information. Any method for determining the color of the corresponding pixel may be used as long as the method corresponds to the tree structure generation method and color information generation method of the image encoding apparatus 100.

As described above, when generation of the decoded color compression vector has been terminated halfway, the image reconstruction unit 205 uses the terminated part as a leaf node and determines the color of the corresponding pixel by using color information about the leaf node as usual. When generation has been terminated, a decoded image may be produced as an image of the same resolution as the original image or as a low-resolution image in which a minimum unit of one pixel is allocated to the deepest leaf node.

For example, if low-resolution decoding is done in the case where block-averaged color has been selected as color information and all the branches have been terminated at the same depth, the decoded image becomes the same as an image obtained when an image without termination is downsampled using a Haar wavelet. Also, decoding at the original resolution in the same case as above generates the same image as an image obtained by upsampling a downsampled image. Also, if the mode of blocks is used as color information, the image obtained is the one produced by sampling from the original image through a mode filter.

Note that if branches are terminated at depths differing from branch to branch, quality of the image can be controlled on a region by region basis. For example, a scheme can be easily implemented in which an ROI (Region of Interest) is established so as to be decoded preferentially.

As described above, the image encoding method performed by the image encoding apparatus 100 according to the embodiment of the present invention expresses an image using pixels or blocks, and colors assigned to the pixels or the blocks when encoding an image to be encoded, and encodes a block division tree and color information, the color information being assigned to all nodes including a root node, branch nodes, and leaf nodes of the block division tree. The image encoding method includes: a division tree generation step of dividing the image to be encoded using an arbitrary division tree and thereby generating the block division tree; a color information determination step of determining representative colors that represent interim blocks or final blocks and assigning the determined colors as color information corresponding to the respective nodes, the interim blocks or the final blocks corresponding to the nodes of the block division tree; a tree encoding step of encoding the block division tree; and a color information encoding step of encoding the color information.

Also, as described above, an image decoding method performed by the image decoding apparatus 200 according to the embodiment of the present invention decodes tree information and color information from code data and decodes an image from the decoded tree information and color information. The image decoding method includes: a tree decoding step of decoding a block division tree from the code data; a color information decoding step of decoding color information corresponding to all nodes including a root node, branch nodes, and leaf nodes of the division tree from the code data; and an image decoding step of decoding the image based on the division tree and the color information.

Being configured as described above, the image encoding apparatus 100 and image decoding apparatus 200 according to the present embodiment express an arbitrary image to be encoded, using pixels, or blocks which are sets of pixels as well as colors assigned to the pixels or the blocks. Also, the image encoding apparatus 100 and the image decoding apparatus 200 express a block division using a tree structure such as a binary tree, a ternary tree, or a quadtree as well as color information possessed by nodes including branch nodes and leaf nodes. By making color information predictions between a parent node and child nodes and tree structure predictions among different tree depths, the image encoding apparatus 100 and the image decoding apparatus 200 can make not only predictions between adjacent pixels, but also global spatial predictions. Also, the image encoding apparatus 100 and the image decoding apparatus 200 can make tree structure predictions by referring to already decoded subtrees. By making tree structure predictions among different tree depths, the image encoding apparatus 100 and the image decoding apparatus 200 enable efficient compression using fractality of the image.

Thus, the image encoding apparatus 100 and image decoding apparatus 200 according to the embodiment of the present invention can improve coding efficiency.

The image encoding apparatus 100 and image decoding apparatus 200 according to the above embodiment may be implemented by a computer. In that case, programs that implement these functions may be recorded on a computer-readable recording medium and read and executed by a computer system to implement the devices. It is assumed that the “computer system” as referred to herein includes an OS and hardware such as peripheral devices. Also, the “computer-readable recording medium” refers to a portable medium such as a flexible disk, a magneto-optical disk, a ROM, or a CD-ROM, or a storage device, built into the computer system, such as a hard disk. Furthermore, the “computer-readable recording medium” may include a recording medium that dynamically holds a program for a short time when a program is transmitted through a network such as the Internet or a communications line such as a telephone line and a recording medium such as a volatile memory that holds the program in the computer system for a set amount of time when the computer system is acting as a server or a client during the transmission. The program may be designed to implement only part of the functions described above or implement the functions described above in conjunction with a program prestored in the computer system. Alternatively, the above functions may be implemented using hardware such as an FPGA (Field Programmable Gate Array) or a PLD (programmable logic device).

Whereas an embodiment of the present invention has been described above with reference to the drawings, the above embodiment is only exemplary of the present invention, and it is apparent that the present invention is not limited to the embodiment described above. Thus, components may be added, omitted, replaced, or otherwise changed without departing from the technical idea and scope of the present invention.

### REFERENCE SIGNS LIST

100 Image encoding apparatus
101 Image input unit
102 Tree determination unit
103 Tree prediction unit
104 Color determination unit
105 Color prediction unit
106 Entropy coding unit
200 Image decoding apparatus
201 Code input unit
202 Entropy decoding unit
203 Tree prediction unit
204 Color prediction unit
205 Image reconstruction unit

1. An image encoding method that expresses an image using pixels or blocks, and colors assigned to the pixels or the blocks when encoding an image to be encoded, and encodes a block division tree and color information, the color information being assigned to all nodes including a root node, branch nodes, and leaf nodes of the block division tree, the method comprising:
a division tree generation step of dividing the image to be encoded using an arbitrary division tree and thereby generating the block division tree;
a color information determination step of determining representative colors that represent interim blocks or final blocks and assigning the determined colors as color information corresponding to the respective nodes, the interim blocks or the final blocks corresponding to the nodes of the block division tree;
a tree encoding step of encoding the block division tree; and
a color information encoding step of encoding the color information.

2. The image encoding method according to claim 1, further comprising a tree prediction step of making a prediction of a subtree, which is that part of the block division tree which is located at or below an arbitrary node, with reference to a reference subtree, which is an already encoded other subtree, and generating a predicted subtree, which is the subtree of which the prediction is made, wherein
the tree encoding step encodes tree prediction information configured to identify the reference subtree and a differential tree configured to identify a difference between the subtree and the predicted subtree.

3. The image encoding method according to claim 2, further comprising a color information adjacency prediction step of generating a color information adjacency prediction value for an arbitrary node to be encoded, with reference to color information about an already encoded parent node or sibling node of the node to be encoded and generating a color information adjacency prediction residual, which is a differential between color information about the node to be encoded and the color information adjacency prediction value, wherein
the color information encoding step treats the color information adjacency prediction residual as an object to be encoded.

4. The image encoding method according to claim 3, further comprising an inter-tree color information prediction step of generating an inter-tree color information prediction value for each node of an arbitrary subtree of the block division tree with reference to the color information corresponding to the reference subtree and generating an inter-tree color information prediction residual, which is a differential between the inter-tree color information prediction value and the color information about the node to be encoded, wherein
the color information encoding step encodes inter-tree color information prediction information and the inter-tree color information prediction residual, the inter-tree color information prediction information being configured to identify the reference subtree.

5. The image encoding method according to claim 4, further comprising a color palette generation step of generating a color palette, which is a set of colors used for the color information, the color information adjacency prediction residual, and the inter-tree color information prediction residual contained in the image, wherein
the color information encoding step encodes the color palette and an index to the color palette.

6. The image encoding method according to claim 1, wherein when encoding the block division tree and the color information, the tree encoding step and the color information encoding step do encoding at each depth level of the block division tree.

7. The image encoding method according to claim 1, wherein the color information determination step designates a mode of the pixels contained in each of the blocks as a representative color and assigns the representative color as the color information corresponding to given one of the nodes.

8. An image decoding method that decodes tree information and color information from code data and decodes an image from the decoded tree information and the color information, the method comprising:
a tree decoding step of decoding a block division tree from the code data;
a color information decoding step of decoding color information corresponding to all nodes including a root node, branch nodes, and leaf nodes of the block division tree from the code data; and
an image decoding step of decoding the image based on the block division tree and the color information.

9. The image decoding method according to claim 8, further comprising a tree prediction step, wherein
the tree decoding step decodes tree prediction information and a differential tree regarding a subtree, which is that part of the block division tree which is located at or below an arbitrary node, the tree prediction information being configured to identify a reference subtree, which is an already decoded other subtree, the differential tree being configured to identify a difference between a predicted subtree and the subtree, where the predicted subtree is the subtree predicted based on the reference subtree.
the tree prediction step generates the predicted subtree with reference to the reference subtree and generates the block division tree from the predicted subtree and the differential tree.

10. The image decoding method according to claim 9, further comprising a color information adjacency prediction step, wherein:
the color information decoding step decodes a color information adjacency prediction residual, which is a differential between color information about a node to be decoded and a color information adjacency prediction value; and
the color information adjacency prediction step generates the color information adjacency prediction value for an arbitrary node to be decoded, with reference to color information about an already encoded parent node or sibling node of the node to be decoded and generates the color information from the color information adjacency prediction value and the color information adjacency prediction residual.

11. The image decoding method according to claim 10, further comprising an inter-tree color information prediction step, wherein:
the color information decoding step decodes inter-tree color information prediction information and an inter-tree color information prediction residual for each node of an arbitrary subtree of the block division tree, the inter-tree color information prediction information being configured to identify an already encoded other reference subtree, the inter-tree color information prediction residual being a differential between an inter-tree color information prediction value and color information about the node to be decoded; and
the inter-tree color information prediction step generates an inter-tree color information prediction value with reference to color information corresponding to the reference subtree and generates the color information from the inter-tree color information prediction value and the inter-tree color information prediction residual.

12. The image decoding method according to claim 11, further comprising a color assignment step, wherein:
the color information decoding step decodes a color palette, and an index to the color palette in each node, the color palette being a set of colors used for the color information, the color information adjacency prediction residual, or the inter-tree color information prediction residual contained in the image; and
the color assignment step generates color information about each node from the color palette and the index.

13. The image decoding method according to claim 8, wherein when decoding the block division tree and the color information, the tree decoding step and the color information decoding step do decoding at each depth level of the block division tree.
